(19) United States
(12) Patent Application Publication
(10) Pub. No.: US 2009/0117245 A1
(43) Pub. Date: May 7, 2009

(54) METHOD FOR COOKING IN AN OVEN AND DEVICE FOR CARRYING OUT SAID METHOD

(75) Inventor: Daniel PEYRAT, Champigny (FR)

Correspondence Address: CONNOLLY BOVE LODGE & HUTZ LLP;(FOR CABINET BEAU DE LOMENIE), P.O. BOX 2207, WILMINGTON, DE, 19899-2207, US

(73) Assignee: CARRE GOURMET DIFFUSION, Valenton (FR)

(21) Appl. No.: 11/568,967

(22) PCT Filed: May 12, 2005
(86) PCT No.: PCT/FR05/01182

§ 371 Date: Nov. 10, 2006

(30) Foreign Application Priority Data
May 13, 2004 (FR) 0405179

(51) Int. Cl. A23L 1/48; A47J 37/01

(52) U.S. Cl. 426/523; 220/573.1

(57) ABSTRACT

The invention provides a method of cooking an intermediate preparation for preparing a cooked dish in an oven, the method being characterized in that it is implemented by placing said intermediate preparation under a device (1) without coming into contact therewith, at least the portion (2) of the device that overlies the top surface of said intermediate preparation presenting a plurality of perforations (3) enabling temperature uniformity to be improved at said top surface, the distance between said top surface and said portion overmounting said top surface, and the size and the distribution of the perforations being selected so as to improve the distribution of the heat communicated by the oven to said intermediate preparation during cooking and/or avoiding local overheating during said cooking. It also provides a cooking bell (1) suitable for implementing the method.

The present invention relates to a method of cooking in an oven and to a device specifically adapted for implementing the method.

The invention relates most particularly to the field of preparing cooked dishes, and in particular pastries.

The invention seeks in particular to solve a certain number of problems that arise when preparing a cooked dish in an oven, in particular when the dish comprises both frozen portions and fresh portions, or when some of its ingredients are particularly sensitive to the effect of drying out under heat and are caused to remain for a relatively long length of time in a hot oven so that other ingredients of the same cooked dish spend enough time in the oven to ensure that they are cooked properly.

Thus, the invention provides a method and a device enabling cooking to be achieved that is both uniform and without local overheating phenomena, in particular at the surface and on the sides of the preparation while it is cooking.

In general, the invention seeks to enable the operation of cooking in an oven to be performed under conditions that enable heat to be distributed more uniformly, and in particular while avoiding local overheating phenomena and the inconveniences thereof concerning the final appearance of the preparation and its taste qualities.

The advantages of the invention are particularly apparent when the cooking time or oven temperature lead to an increased risk of degrading the quality of certain ingredients that are particularly sensitive to heat.

Thus, the invention provides a method and a device enabling cooking to be performed in an oven under good conditions of heat distribution so as to improve both the final appearance of the preparation and its taste qualities.

Without being limited in any way to this type of application, the invention applies most particularly to preparing cooked dishes, in particular pastries, made from intermediate preparations that have been prepared beforehand and for which final cooking, a step of partial cooking or of thawing, is performed in an oven. During this step, it is not unusual to desire to use simultaneously both a frozen portion and fresh portions in order to make the intended cooked dish, which can lead to a risk of the fresh portions being overheated since they are often fragile, and it is desired to cook the frozen portion sufficiently, which requires heat to be delivered for longer.

Thus, the inventor of the present invention has now discovered that it is possible to greatly improve all cooking operations that require accurate control over temperature so as to avoid the above-mentioned drawbacks by performing the step of cooking in an oven by placing the preparation for cooking under a device referred to below as a cooking bell, so as to improve the distribution of the heat that is delivered by the oven to the preparation throughout cooking, and to optimize the appearance and the qualities of the preparation.

Thus, in a first aspect, the invention provides a method of cooking an intermediate preparation for preparing a cooked dish in an oven, the method being characterized in that it is implemented by placing said intermediate preparation under a device without coming into contact therewith, at least the portion of the device that overlies the top surface of said intermediate preparation presenting a plurality of perforations enabling temperature uniformity to be improved at said top surface, the distance between said top surface and said portion overmounting said top surface, and the size and the distribution of the perforations being selected so as to improve the distribution of the heat communicated by the oven to said intermediate preparation during cooking and/or avoiding local overheating during said cooking.

In a second aspect, the invention provides a novel device constituted by a cooking bell for cooking in an oven and characterized in that it comprises a portion for overlying the top surface of the preparation for cooking and presenting a plurality of perforations of size and/or distribution providing temperature uniformity at the top surface of the preparation while it is cooking, and means for avoiding contact with said preparation and for adjusting the distance between the portion having the perforations and the top surface of the preparation for cooking.

Below, the term intermediate preparation for preparing a cooked dish is used to designate the preparation that is put into the oven at the beginning of the cooking step. It may be constituted equally well by a food preparation that is raw or that is partially cooked or that is frozen, or a mixture associating different items, each of which may be raw, frozen, or precooked.

Thus, the term intermediate preparation is used to designate the preparation that is put into the oven, as contrasted with the final cooked dish obtained at the end of the step of cooking in the oven.

The term cooking in an oven covers any operation that results from the action of heat in the oven on the preparation. This can thus be constituted equally well by partial or complete cooking operation, or by a thawing operation, or by a simultaneous operation both of partial or complete cooking and of thawing.

Throughout the operation referred to as cooking in an oven, the intermediate preparation is placed under the device of the invention that thus forms a bell thereover. The bell may have various physical shapes, providing it does not come directly into contact with the intermediate preparation.

Apart from the fact that there is no contact with the preparation for cooking, the device of the invention is characterized by the presence of perforations distributed over the entire area of the device that overlies the surface of the intermediate preparation and the fact that it is possible to adjust the distance between the perforated portion and the top surface of the preparation for cooking in such a manner as to optimize cooking conditions and avoid the drawbacks known in the prior art, and in particular avoid degrading fragile substances, in particular fresh produce, under the effect of heat.

The invention lies firstly in selecting dimensions and/or a distribution for the perforations in the cooking bell and secondly in selecting the most appropriate distance between the top portion of the cooking bell having the perforations and the surface of the preparation that is to be cooked in the oven.

These two selections make it possible to obtain the desired effect of improving the distribution of the heat communicated by the oven to the intermediate preparation while it is cooking and avoid local overheating of the preparation. This serves simultaneously to improve the uniformity of the temperature at the top surface of the preparation throughout the cooking step and to optimize the result of the cooking so as to obtain a dish presenting both better appearance and better taste qualities.

In a first advantageous variant, the perforations are larger in the center of the portion overlying the top surface of the intermediate preparation than at its periphery.

In a second variant implementation of the method of the invention, a device is selected in which the spacing between the perforations increases from the periphery of the portion overlying the top surface of the intermediate preparation going towards the center thereof.

The cooking bell may have various shapes providing it does not come directly into contact with the intermediate preparation for cooking and rests on the oven plate or the bottom of the oven that also serves to support the preparation for cooking, possibly placed in a dish. The surface having the perforations may in particular be domed to a greater or lesser extent.

In a particularly advantageous variant, the bell may stand on the oven plate or the bottom of the oven via legs of height that may be variable, for example, so as to accommodate the height of the preparation for cooking and obtain a cooking temperature that is as uniform as possible.

The distance between the surface having the perforations and the surface of the preparation for cooking may be variable. This distance is not critical. Nevertheless, it is advantageously selected to lie in the range 2 centimeters (cm) to 5 cm. This distance may in particular be adjusted by acting on the length of adjustable legs.

The legs may be of various shapes. Nevertheless, given that the cooking bell is generally for placing on a cooking grid, the legs should be selected to have a shape that will provide good stability, particularly when they are stood on a grid. In particular, legs should be selected that present bottom ends that are enlarged to improve stability.

In addition to the perforated portion overlying the surface of the preparation for cooking, the bell may also have a side portion forming a lateral heat screen for contributing to the effect of the bell in avoiding any overheating on the sides of the preparation.

Amongst other shapes, this side portion may be in the form of a sidewall.

The height of the bell, possibly including a sidewall-forming portion, is likewise not critical. Nevertheless, account needs to be taken of constraints associated with the filling capacity of the oven. This is particularly true when using an industrial type circulating-air oven which generally has a succession of cooking stages and in which it is important to take care that the cooking bell does not take up too much useful space inside the oven.

The cooking bell of the invention may be made of any material that withstands the temperature of the oven.

In particular, it may be a bell made of metal, e.g. aluminum, or made of a material that withstands oven heat, such as card treated to withstand oven heat or terra-cotta.

In a variant of the invention, the area of the holes may be modified either before or during a cooking operation.

To this end, the cooking bell may be provided with means suitable for varying the dimensions or the numbers of perforations.

In particular, such means may be implemented by a system of moving shutters serving to close the areas of some or all of the perforations completely or in part.

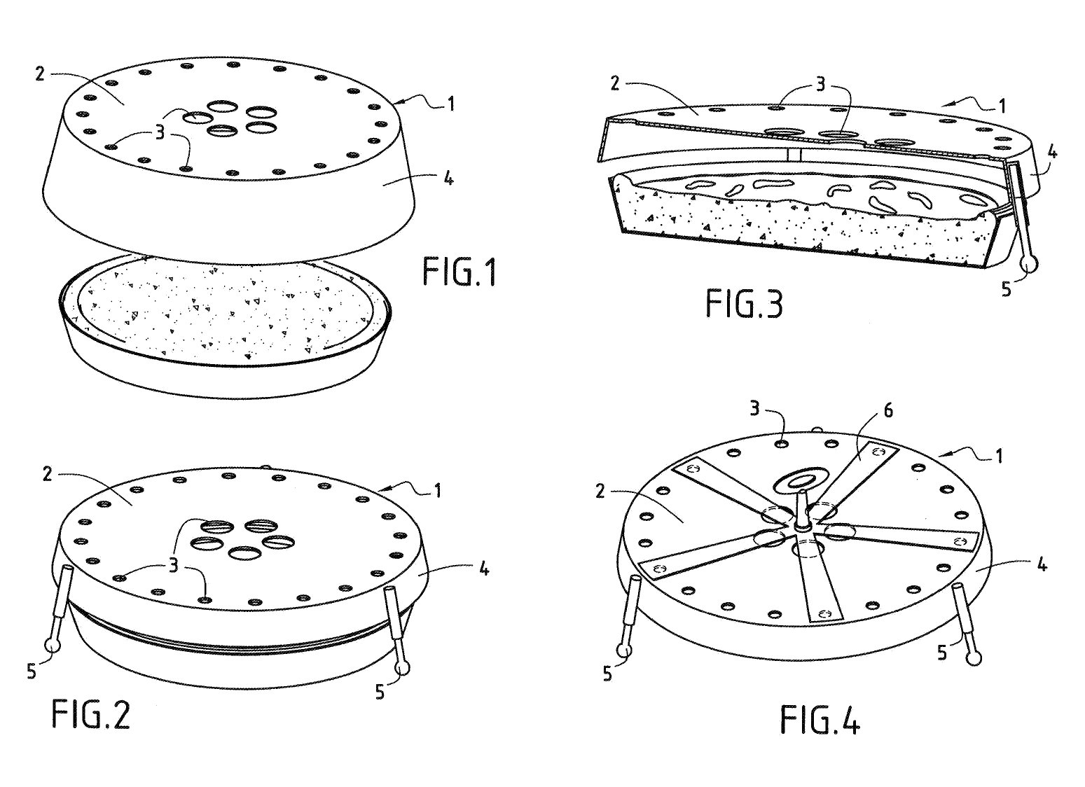

The cooking bell of the invention is particularly advantageous in various types of cooking as can be seen from the detailed description given below, in particular with reference to FIGS. 1 to 4.

FIG. 1 shows an example of a cooking bell of the invention.

FIG. 2 shows another example of a cooking bell of the invention.

FIG. 3 is a section view showing a cooking bell of the invention over a dish being cooked.

FIG. 4 shows a cooking bell of the invention having movable shutters for closing some of the perforations.

From the following detailed description given with reference to the figures, the person skilled in the art will readily understand that it is possible to improve the distribution of heat by means of the device of the invention by carrying out simple routine tests and by relying essentially on the appearance and the taste qualities of the end result.

FIG. 1 shows a cooking bell 1 comprising a portion for placing over a dish while it is cooking, the figure showing the dish under the bell prior to the bell being put down thereon.

The top portion 2 of the bell 1 has two rows of perforations 3, the perforations in the outer row being smaller than those in the inner row.

In FIG. 1, the dish is placed inside a dish, and depending on the dimensions of the sidewall 4 of the bell, the bell will rest either on the top edges of the dish or else will stand on the same plate that is carrying the dish if the diameter of the bell is slightly greater than that of the dish.

In this variant, the height of the sidewall is selected so as to improve temperature uniformity during cooking.

FIG. 2 shows another type of cooking bell of the invention.

This bell has legs 5 that may be adjustable in length, thus constituting a preferred variant of the invention.

FIG. 3 shows the same device as FIG. 2, but in section view.

FIG. 4 shows a lid of the same type as shown in FIG. 2 but further presenting a system of movable shutters 6 serving to close at will some or all of the openings included in the top surface 2 of the bell.

In the device of FIG. 4, the shutters are placed on the top surface of the bell. They could also be located under the top surface of the bell.

Furthermore, it will readily be understood that the presence of the shutters should make it possible at will to close some or all of the perforations contained in the cooking bell throughout the duration of cooking in an oven.

In particular, it is possible to use shutters which instead of being movable as shown in FIG. 4, could be of variable length. Under such circumstances, by acting on the length of each shutter, it is possible at will to close or leave open one or more perforations.

It is also possible to envisage making use of shutters that are both movable and variable in length.

In the various figures, two concentric rows of perforations are shown comprising a row of smaller perforations in the outermost portion and a row of larger perforations towards the center.

Naturally, other dispositions of perforations could be provided, the purpose being to improve the distribution of heat at the surface of the food being cooked, and in particular to avoid overheating fragile substances that are sensitive to heat and that might be found on the surface.

This protection using the surface 1 is also assisted by the presence of a sidewall 4.

It will easily be understood that since the function of the sidewall is to act as a screen for preserving the integrity of a temperature-sensitive topping present on the surface of the food for cooking in the oven, it is advantageous for the height of the sidewall to be sufficient to ensure that it performs the screen function. Nevertheless, the sidewall must not be too tall, in particular to avoid impeding proper transmission of heat to the underlying portion.

The bottom portion of the sidewall-forming portion is advantageously located only a little below the surface of the food for cooking. To obtain this result, the height of the sidewall should be selected appropriately, but it is also possible to adjust the length of the legs of the cooking bell.

The device and the method are particularly advantageous whenever it is desired to improve the distribution of heat during a step of cooking in an oven, and it applies to all types of oven.

Nevertheless, the device and the method of the invention turn out to be particularly advantageous when cooking is performed in a circulating-air oven, insofar as it is well known that given the way heat is distributed in such an oven, the surface of the food and the sides thereof are particularly vulnerable to the effect of the heat and to surface drying.

The method and the device of the invention are advantageous in all types of oven cooking in which it is desired to achieve better control over heat, in particular so as to avoid local overheating.

There are equally applicable to preparing cooked dishes whether sweet or savoury.

Nevertheless, the invention is particularly advantageous to pastry baking operations, in particular both sweet pastries and savoury pastries. The invention is particularly advantageous when the pastries are prepared starting from an intermediate preparation having at its surface substances that are particularly sensitive to high temperatures. This applies in particular to fresh fruit that may be placed in the form of pieces or slices or whole on the surface of a tart. With savoury pastries, such as quiches, this applies likewise to pieces of fish or bacon that may be placed on the surface of the quiche, and that are particularly sensitive to being dried out by heat.

The device and the method of the invention are particularly advantageous when the cooked dish is prepared, at least in part, from a frozen preparation that must be subjected to oven temperature for a sufficient length of time to achieve its normal unfrozen and cooked state. The fact that such dishes require cooking for a relatively long time in an oven makes the portions thereof that are sensitive to heat (such as fresh produce) even more vulnerable and it will readily be understood that the device of the invention is even more advantageous for cooked dishes comprising both portions that are initially frozen and portions that are fresh.

The invention also applies to cooking intermediate preparations containing a succession of previously-frozen layers.

This applies in particular to thawing and/or cooking preparations made up of a succession of previously-frozen layers. Such preparations are described in particular in French patent application FR 2 693 444 which describes a method of manufacturing a cooked dish from individual culinary compositions in the form of slabs.

As explained above, the invention applies most particularly to savoury or sweet pastries, and in particular to pies whether sweet or savoury, and in particular to pies or tarts comprising simultaneously a pastry base, a filling, and fresh produce.

International patent application wO 97/49292 describes slabs of food for making up layers of a dish comprising a plurality of layers of foodstuffs. The slabs described in that document present the specific feature of presenting a plurality of cavities.

By way of example, such slabs could be constituted by a quiche filling and they could be ready to receive pieces of bacon in the cavities.

When such slabs constitute the top portion of an intermediate preparation, the heat-sensitive substances that are placed in the cavities (e.g. pieces of bacon for a slab for use in preparing a quiche), are thus particularly exposed to heat during the step of thawing the slab, and in particular so long as the fragile substances placed in the cells have not been covered by the material constituting the top portions of the cells that will come to cover them as the slab thaws. This constitutes an example where use of the cooking bell of the invention turns out to be particularly advantageous and serves to prevent substances that are more sensitive to heat becoming overheated (the pieces of bacon in this example) while the slab constituting the quiche filling is itself thawing out.

This example is naturally given purely as an illustration of the advantage of the device and the method of the invention and shows how the invention makes it possible to improve cooking of portions that are more or less sensitive to heat or that require quantities of heat that differ from one another.

1. A method of cooking an intermediate preparation for preparing a cooked dish in an oven, the method being characterized in that it is implemented by placing said intermediate preparation under a device without coming into contact therewith, at least the portion of the device that overlies the top surface of said intermediate preparation presenting a plurality of perforations enabling temperature uniformity to be improved at said top surface, the distance between said top surface and said portion overmounting said top surface, and the size and the distribution of the perforations being selected so as to improve the distribution of the heat communicated by the oven to said intermediate preparation during cooking and/or avoiding local overheating during said cooking.

2. A method according to claim 1, characterized in that said perforations are larger at the center of said portion overlying the top surface of said intermediate preparation than at its periphery.

3. A method according to claim 1, characterized in that the spacing between said perforations increases from the periphery of said portion overlying the top surface of said intermediate preparation going towards its center.

4. A method according to claim 1, characterized in that said device is of variable height so as to take account of the height of said intermediate preparation, thereby improving the distribution of heat communicated by the oven and/or avoiding local overheating of the intermediate preparation while it is cooking.

5. A method according to claim 1, characterized in that said device includes a portion forming a lateral screen against the action of heat.

6. A method according to claim 1, characterized in that the dimensions and/or the numbers of perforations can be modified.

7. A method according to claim 1, characterized in that said intermediate preparation is used in preparing a sweet or savoury cooked dish, in particular a sweet or savoury pastry.

8. A method according to claim 1, characterized in that said intermediate preparation includes on its surface substances that are sensitive to heat.

9. A method according to claim 1, characterized in that said intermediate preparation contains at least one frozen portion.

10. A method according to claim 9, characterized in that said intermediate preparation contains a succession of previously-frozen layers.

11. A method according to claim 1, characterized in that said intermediate preparation comprises a frozen portion and a fresh portion.

12. A method according to claim 11, characterized in that said intermediate preparation comprises, at its surface, a frozen layer presenting cells.

13. A method according to claim 12, characterized in that said cells contain substances that are fresh or sensitive to heat.

14. A method according to claim 1, characterized in that the oven is a circulating-air oven.

15. A cooking bell for cooking in an oven, the bell being characterized in that it comprises a portion for overlying the top surface of the preparation for cooking and presenting a plurality of perforations of size and/or distribution providing temperature uniformity at the top surface of the preparation while it is cooking, and means for avoiding contact with said preparation and for adjusting the distance between the portion having the perforations and the top surface of the preparation for cooking.

16. A cooking bell according to claim 15, characterized in that said means are legs.

17. A cooking bell according to claim 16, characterized in that said legs are adjustable in length.

18. A cooking bell according to claim 15, characterized in that it includes means serving to constitute a lateral heat screen.

19. A cooking bell according to claim 18, characterized in that said means serving to constitute a lateral heat screen are constituted by a sidewall.

20. A cooking bell according to claim 15, characterized in that it includes means for modifying the sizes and/or the numbers of the perforations, such as movable shutters and/or variable-length shutters.
